(19) United States
(12) Patent Application Publication
(10) Pub. No.: US 2024/0403891 A1
(43) Pub. Date: Dec. 5, 2024

(54) DIGITIZED DEVICE REGULATORY LABELS FOR INFORMATION TECHNOLOGY ASSETS

(71) Applicant: Dell Products L.P., Round Rock, TX (US)

(72) Inventors: Peter C. Casini, Pflugerville, TX (US); Todd Allen Bath, Dripping Springs, TX (US)

(21) Appl. No.: 18/325,263

(22) Filed: May 30, 2023

(51) Int. Cl. G06Q 30/018

(52) U.S. Cl. CPC G06Q 30/018

(57) ABSTRACT

An apparatus comprises a processing device configured to identify content to be displayed on at least one version of a digitized device regulatory label for an information technology asset, to generate the at least one version of the digitized device regulatory label for the information technology asset, to provision, in a memory of the information technology asset, the generated at least one version of the digitized device regulatory label for the information technology asset, and to control output of the generated at least one version of the digitized device regulatory label on a display of the information technology asset.

### FIELD

The field relates generally to information processing, and more particularly to management of information processing systems.

### BACKGROUND

Various electronic products, including computing, storage and networking equipment, are required to include packaging and labeling with various identifying information. Electronic products typically include device regulatory labels in the form of stickers which are affixed to an exterior surface of the electronic products. Such device regulatory labels may include various identifying information for the electronic products, as well as marks which certify compliance of the electronic products with standards promulgated by different organizations. In order for an electronic product to be imported for sale in a particular country or other geographic region, its device regulatory label may be inspected to ensure it has any required certification marks for that country or other geographic region.

### SUMMARY

Illustrative embodiments of the present disclosure provide techniques for managing digitized device regulatory labels for information technology assets.

In one embodiment, an apparatus comprises at least one processing device comprising a processor coupled to a memory. The at least one processing device is configured to identify content to be displayed on at least one version of a digitized device regulatory label for an information technology asset, to generate the at least one version of the digitized device regulatory label for the information technology asset, to provision, in a memory of the information technology asset, the generated at least one version of the digitized device regulatory label for the information technology asset, and to control output of the generated at least one version of the digitized device regulatory label on a display of the information technology asset.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for managing digitized device regulatory labels for information technology assets in an illustrative embodiment.

FIGS. 2A and 2B show details of a sample device regulatory label in an illustrative embodiment.

FIG. 3 is a flow diagram of an exemplary process for managing digitized device regulatory labels for information technology assets in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

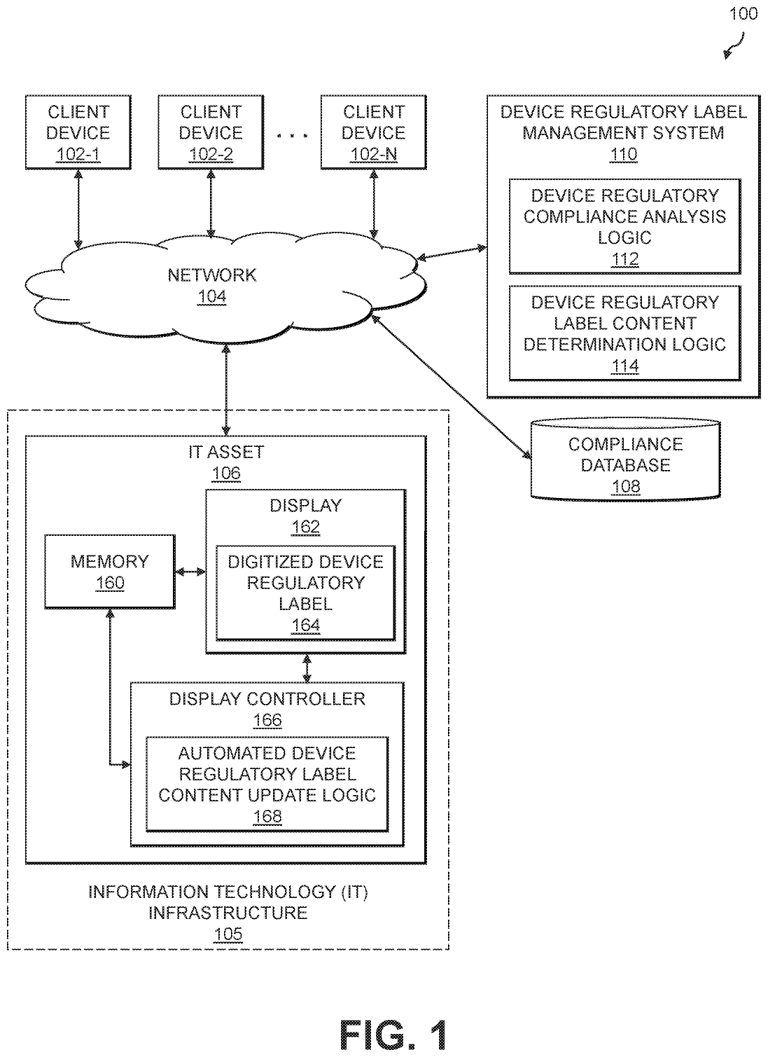

FIG. 1 shows an information processing system 100 configured in accordance with an illustrative embodiment to provide functionality for managing digitized device regulatory labels for information technology (IT) assets. The information processing system 100 includes a set of client devices 102-1, 102-2, . . . 102-N (collectively, client devices 102) which are coupled to a network 104. Also coupled to the network 104 is an IT infrastructure 105 comprising at least one IT asset 106, a compliance database 108, and a device regulatory label management system 110. The IT asset 106 is assumed to comprise one or more physical computing resources in the IT infrastructure. The physical computing resources may include physical hardware such as one or more servers, storage systems, networking equipment, Internet of Things (IoT) devices, other types of processing and computing devices including desktops, laptops, tablets, smartphones, etc. The physical computing resources may be used to implement one or more virtual computing resources, such as virtual machines (VMs), containers, etc.

The IT asset 106 of the IT infrastructure 105 may host applications that are utilized by respective ones of the client devices 102, such as in accordance with a client-server computer program architecture. In some embodiments, the applications comprise web applications designed for delivery from assets in the IT infrastructure 105 to users (e.g., of client devices 102) over the network 104. Various other examples are possible, such as where one or more applications are used internal to the IT infrastructure 105 and not exposed to the client devices 102.

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The compliance database 108 is configured to store and record various information that is used by the device regulatory label management system 110 and/or the IT asset 106 for setting and updating device regulatory labels. Such information may include, for example, regulatory compliance standards, lists of devices (or hardware and/or software components thereof) which do and do not comply with different regulatory compliance standards, etc. In some embodiments, one or more storage systems utilized to implement the compliance database 108 comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the IT asset 106 and/or the device regulatory label management system 110, as well as to support communication between the IT asset 106, the device regulatory label management system 110 and other related systems and devices not explicitly shown.

The client devices 102 are configured to access or otherwise utilize the IT infrastructure 105, including the IT asset 106. In some embodiments, the client devices 102 are assumed to be associated with system administrators, IT managers or other authorized personnel responsible for managing the IT asset 106 of the IT infrastructure 105 (e.g., where such management includes setting or otherwise controlling device regulatory labels for IT assets of the IT infrastructure 105 including the IT asset 106). For example, a given one of the client devices 102 may be operated by a user to access a graphical user interface (GUI) provided by the device regulatory label management system 110 to generate or update a device regulatory label for one or more of the IT assets of the IT infrastructure 105, such as IT asset 106. The device regulatory label management system 110 may be provided as a cloud service that is accessible by the given client device 102 to allow the user thereof to manage device regulatory labels for one or more of the IT assets of the IT infrastructure 105, including IT asset 106. In some embodiments, the IT assets of the IT infrastructure 105 are owned or operated by the same enterprise that operates the device regulatory label management system 110 (e.g., where an enterprise such as a business provides support for the assets it operates). In other embodiments, the IT assets of the IT infrastructure 105 may be owned or operated by one or more enterprises different than the enterprise which operates the device regulatory label management system 110 (e.g., a first enterprise provides support for assets that are owned by multiple different customers, business, etc.). Various other examples are possible.

In some embodiments, the client devices 102 and/or the IT assets of the IT infrastructure 105, including IT asset 106, may implement host agents that are configured for automated transmission of information regarding device regulatory labels (e.g., information utilized for determining which certification marks may be used for the device regulatory labels thereof). Such host agents may also or alternatively be configured to automatically receive from the device regulatory label management system 110 commands or instructions (e.g., to update or modify the content of device regulatory labels).

It should be noted that a “host agent” as this term is generally used herein may comprise an automated entity, such as a software entity running on a processing device. Accordingly, a host agent need not be a human entity.

In the FIG. 1 embodiment, the IT asset 106 comprises a memory 160, a display 162, and a display controller 166. The memory 160 is provisioned with regulatory labeling information for the IT asset 106 that is output as a digitized device regulatory label 164 on the display 162. In some embodiments, the display 162 comprises a low-power display which is dedicated for use in displaying the digitized device regulatory label 164. The display 162, for example, may comprise an electronic ink (e-ink) display which is configured to output the digitized device regulatory label 164. The display 162 may be configured to run continuously (e.g., such that the digitized device regulatory label 164 is constantly displayed), or may be activated or powered on as controlled by the display controller 166. The display controller 166 may comprise one or more user interface features (e.g., buttons, switches, etc.) which can power the display 162 on or off on demand, or which may update the display 162 in order to show the digitized device regulatory label 164 on demand. The display controller 166 may, in some cases, may be accessed by one or more of the client devices 102 in order to control whether the display 162 is powered on or off, or whether the digitized device regulatory label 164 is currently shown on the display 162.

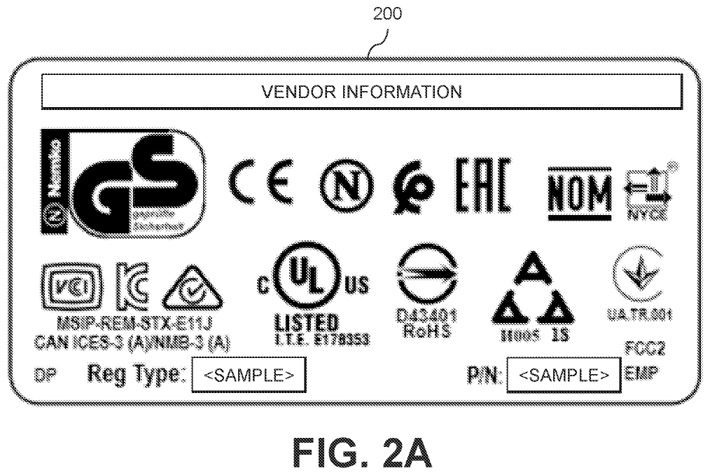

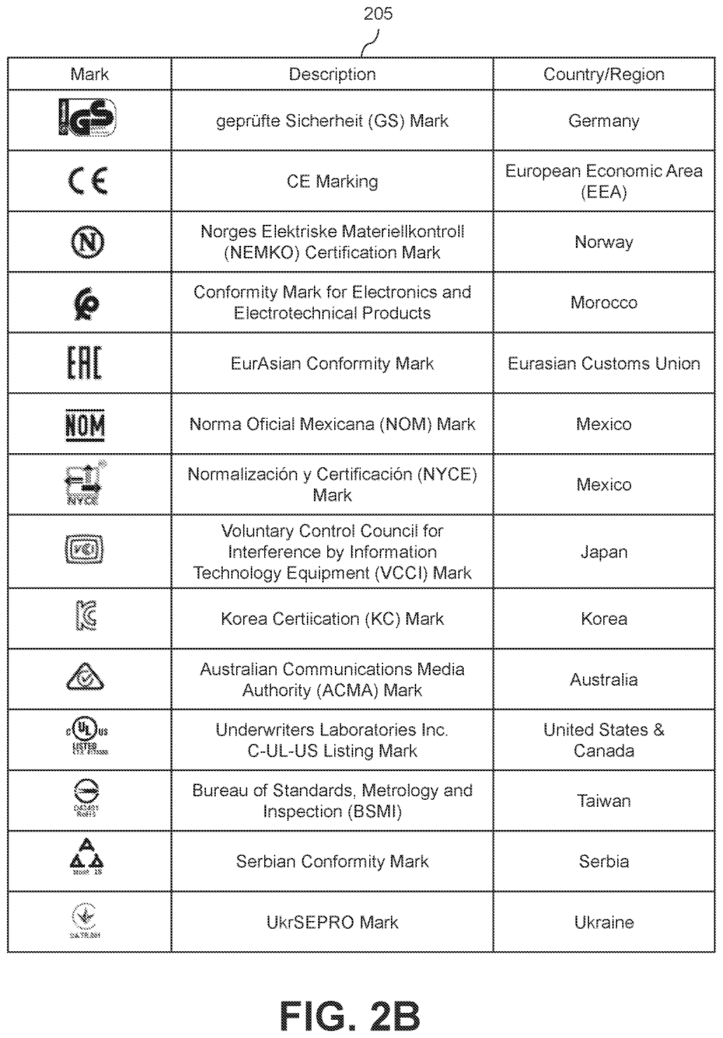

The digitized device regulatory label 164 may comprise or include a set of certification marks indicating compliance of the IT asset 106 with associated certification standards. FIG. 2A shows an example of a device regulatory label 200, which includes various certification marks along with vendor information (e.g., for an entity or enterprise which manufactures or sells the IT asset 106). The device regulatory label 200 may also include registration type and part number (P/N) information. FIG. 2B shows a table 205 illustrating descriptions and applicable countries or regions where the different certification marks are applicable. In some cases, certification marks are mandatory, in that a particular certification mark must be displayed in order for an associated product to be imported and sold into an associated country or other geographic region (e.g., one or more states or provinces, or groups thereof, within a country, groups of countries, etc.). It should be appreciated that the various certification marks shown in FIGS. 2A and 2B are presented by way of example only, and that digitized device regulatory labels may include any one of or a combination of these and other certification marks, including variations of the certification marks shown in FIGS. 2A and 2B.

In some embodiments, the memory 160 of the IT asset 106 is provisioned with multiple different versions of the digitized device regulatory label 164, such as a first version of the digitized device regulatory label 164 for a first country or other geographic region, a second version of the digitized device regulatory label 164 for a second country or other geographic region, etc. The display controller 166 may determine the appropriate version of the digitized device regulatory label 164 to output on the display 162 based on various factors, including a current physical location of the IT asset 106, an intended physical location of the IT asset 106, etc. For example, the IT asset 106 may be provisioned, at a factory, with the multiple versions of the digitized device regulatory label 164 and placed into a stock of inventory. When the IT asset 106 is sold from the stock of inventory to a particular customer or other end-user in a particular geographic location, the display controller 166 may be updated with such information in order to select an appropriate one of the multiple versions of digitized device regulatory label 164 which should be presented on the display 162. The display controller 166 may also include user interface features (e.g., buttons, switches, etc.) that allow a user to cycle through the different versions of the digitized device regulatory label 164 which are provisioned in the memory 160 to select a specific version for output on the display 162. Various other examples are possible.

In some embodiments, the IT asset 106 includes one or more location-determining components (e.g., a Global Positioning System (GPS) unit). The display controller 166 may be configured to obtain location information from such location-determining components (or from communications with the network 104) to determine a location of the IT asset 106 and change the digitized device regulatory label 164 automatically in response to the determined location of the IT asset 106. The display controller 166 may also be configured to automatically detect which hardware and/or software components are included in the IT asset 106, and to generate and display the digitized device regulatory label 164 accordingly (e.g., to display any certification marks associated with such components, possibly via comparison against a stored list of particular hardware and/or software components which require particular certification marks, where the list may be stored locally or obtained from the compliance database 108). Various other examples are possible.

The display controller 166 also implements automated device regulatory label content update logic 168, which is configured to update the content of the digitized device regulatory label 164. This may include writing or rewriting the memory 160 to indicate a set of certification marks which should be displayed as part of the digitized device regulatory label 164. The automated device regulatory label content update logic 168, for example, may monitor the IT asset 106 for one or more changes (e.g., relating to hardware and/or software components thereof) which may affect which certification marks can and cannot be included in the digitized device regulatory label 164. The automated device regulatory label content update logic 168 may update the memory 160 with information relating to a set of certification marks which are currently applicable for the IT asset 106 and which may be displayed as part of the digitized device regulatory label 164. It should be noted that the set of certification marks for the IT asset 106 may change over time, due to either changes in the hardware and/or software components thereof, or due to changes in certification standards associated with different ones of the set of certification marks.

The automated device regulatory label content update logic 168 may further be configured to control the content of the digitized device regulatory label 164 based on a target “audience.” The IT asset 106, for example, may be moved between different physical locations (e.g., different countries or other geographic regions) associated with different required certification standards. If it is determined that the IT asset 106 is in (or is to be moved to) a given physical location (e.g., a data center) which is associated with a given set of regulatory standards, the automated device regulatory label content update logic 168 may determine compliance of the IT asset 106 with the given set of regulatory standards in order to update the digitized device regulatory label 164 such that it presents certification marks which are relevant for the given set of regulatory standards associated with the given physical location. Thus, different versions of the digitized device regulatory label 164 may be output based on a determined physical location of the IT asset 106.

The device regulatory label management system 110 in the FIG. 1 embodiment is assumed to be implemented using at least one processing device. Each such processing device generally comprises at least one processor and an associated memory, and implements one or more functional modules or logic for controlling certain features of the device regulatory label management system 110. In the FIG. 1 embodiment, the device regulatory label management system 110 implements device regulatory compliance analysis logic 112 and device regulatory label content determination logic 114. The device regulatory compliance analysis logic 112 is configured to monitor the IT asset 106 in order to determine compliance of the IT asset 106 with one or more regulatory standards associated with one or more certification marks. This may include, for example, obtaining an inventory of hardware and/or software components of the IT asset 106, and searching the compliance database 108 to determine whether such hardware and/or software components of the IT asset 106 comply with regulatory standards associated with different certification marks. The may also or alternatively include looking up the IT asset 106 itself in the compliance database 108, to determine whether the IT asset 106 as a whole complies with regulatory standards associated with different certification marks.

The device regulatory label content determination logic 114 is configured to generate content for the digitized device regulatory label 164 based at least in part on the determined compliance of the IT asset 106 with the one or more regulatory standards associated with the one or more certification marks. The generated content may comprise, for example, a list of certification marks which may be displayed as part of the digitized device regulatory label 164. In some cases, the generated content may comprise an initial provisioning of the content of the digitized device regulatory label 164 (e.g., which is written to the memory 160 of the IT asset 106). The memory 160 may be a read-only memory which is only provisioned once with the content for the digitized device regulatory label 164. In other embodiments, the memory 160 may be rewriteable or flash-able, and may be provisioned and re-provisioned with updated content for the digitized device regulatory label 164. For example, content of the digitized device regulatory label 164 may be updated when the IT asset 106 is first manufactured and sold, when the IT asset 106 is re-sold, when the IT asset 106 is to be moved to a different physical location (e.g., where different physical locations are associated with different regulatory standards and requirements for which certification marks must be displayed in order for the IT asset 106 to be sold or imported to the different physical locations, etc.), when the hardware and/or software components of the IT asset 106 are changed, when regulatory standards associated with certification marks change (e.g., including when the regulatory standards associated with one or more certification marks which are included on the digitized device regulatory label 164 have changed), etc.

At least portions of the device regulatory compliance analysis logic 112, the device regulatory label content determination logic 114 and the automated device regulatory label content update logic 168 may be implemented at least in part in the form of software that is stored in memory and executed by a processor.

It is to be appreciated that the particular arrangement of the client devices 102, the IT infrastructure 105, the IT asset 106, the compliance database 108 and the device regulatory label management system 110 illustrated in the FIG. 1 embodiment is presented by way of example only, and alternative arrangements can be used in other embodiments. As discussed above, for example, the device regulatory label management system 110 (or portions of components thereof, such as one or more of the device regulatory compliance analysis logic 112 and the device regulatory label content determination logic 114) may in some embodiments be implemented internal to one or more of the client devices 102 and/or the IT infrastructure 105.

The device regulatory label management system 110 and other portions of the information processing system 100, as will be described in further detail below, may be part of cloud infrastructure.

The device regulatory label management system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, the IT infrastructure 105, the IT asset 106, the compliance database 108 and the device regulatory label management system 110 or components thereof (e.g., the device regulatory compliance analysis logic 112 and the device regulatory label content determination logic 114) may be implemented on respective distinct processing platforms, although numerous other arrangements are possible. For example, in some embodiments at least portions of the device regulatory label management system 110 and one or more of the client devices 102, the IT infrastructure 105 and/or the compliance database 108 are implemented on the same processing platform. A given client device (e.g., 102-1) can therefore be implemented at least in part within at least one processing platform that implements at least a portion of the device regulatory label management system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, the IT asset 106, the compliance database 108 and the device regulatory label management system 110, or portions or components thereof, to reside in different data centers. Numerous other distributed implementations are possible. The device regulatory label management system 110 can also be implemented in a distributed manner across multiple data centers.

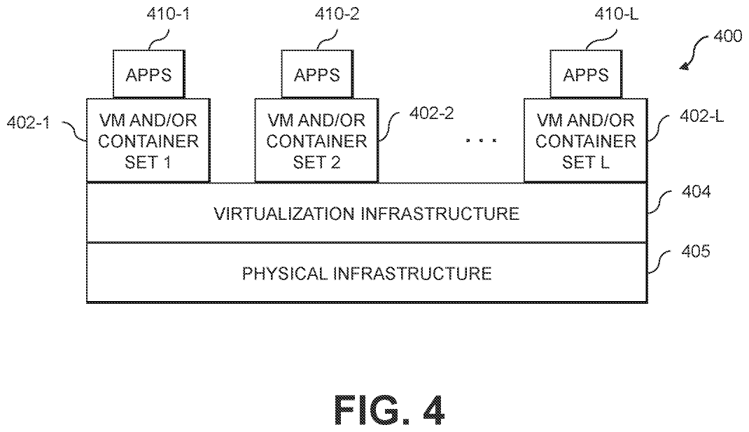

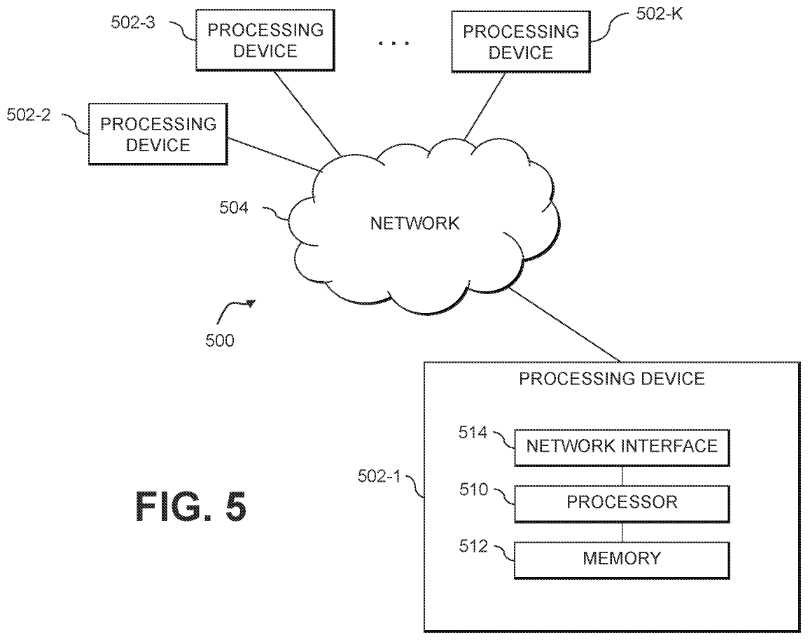

Additional examples of processing platforms utilized to implement the device regulatory label management system 110 and other components of the information processing system 100 in illustrative embodiments will be described in more detail below in conjunction with FIGS. 4 and 5.

It is to be appreciated that these and other features of illustrative embodiments are presented by way of example only, and should not be construed as limiting in any way.

It is to be understood that the particular set of elements shown in FIG. 1 for managing digitized device regulatory labels for IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

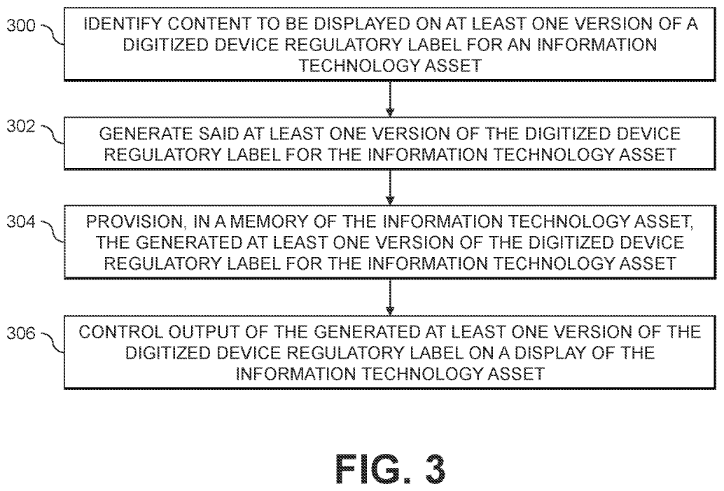

An exemplary process for managing digitized device regulatory labels for IT assets will now be described in more detail with reference to the flow diagram of FIG. 3. It is to be understood that this particular process is only an example, and that additional or alternative processes for managing digitized device regulatory labels for IT assets may be used in other embodiments.

In this embodiment, the process includes steps 300 through 306. These steps are assumed to be performed by the display controller 166 of the IT asset 106 utilizing the automated device regulatory label content update logic 168 and/or the device regulatory label management system 110 utilizing the device regulatory compliance analysis logic 112 and the device regulatory label content determination logic 114. The process begins with step 300, identifying content to be displayed on at least one version of a digitized device regulatory label (e.g., digitized device regulatory label 164) for an IT asset (e.g., IT asset 106). In step 302, the at least one version of the digitized device regulatory label 164 for the IT asset 106 is generated. The generated at least one version of the digitized device regulatory label 164 for the IT asset 106 is provisioned in a memory (e.g., memory 160) of the IT asset 106 in step 304. In step 306, output of the generated at least one version of the digitized device regulatory label 164 on a display (e.g., display 162) of the IT asset 106 is controlled.

The FIG. 3 process, as noted above, may be performed utilizing the display controller 166 of the IT asset 106 which is coupled to the display 162. The display controller 166 may comprise one or more interface features for selectively controlling the output of the generated at least one version of the digitized device regulatory label 164 on the display 162 of the IT asset 106. The generated at least one version of the digitized device regulatory label 164 may comprise two or more versions of the digitized device regulatory label 164, and the one or more interface features may enable selection of a given one of the two or more versions of the digitized device regulatory label 164 to output on the display 162 of the IT asset 106.

In some embodiments, the display 162 comprises a dedicated display for outputting the digitized device regulatory label 164. The dedicated display may comprise an electronic ink display.

Step 302 may comprise generating a first version of the digitized device regulatory label 164 for a first geographic region and at least a second version of the digitized device regulatory label 164 for a second geographic region, the second geographic region being different than the first geographic region. Step 306 may comprise determining whether the IT asset 106 is present in one of the first geographic region and the second geographic region. Responsive to determining that the IT asset 106 is present in the first geographic region or is to be moved to the first geographic region, step 306 may include outputting the first version of the digitized device regulatory label 164 on the display 162 of the IT asset 106. Responsive to determining that the IT asset 106 is present in the second geographic region or is to be moved to the second geographic region, step 306 may include outputting the second version of the digitized device regulatory label 164 on the display 162 of the IT asset 106.

The content of the generated at least one version of the digitized device regulatory label 164 may comprise a set of one or more certification marks associated with one or more certification standards. Steps 300 through 304 may be performed in response to detecting one or more changes in status of the IT asset 106. The one or more changes in the status of the IT asset 106 may comprise: detecting that the IT asset 106 has been sold to an end-user in a given geographic region; detecting one or more changes in at least one of hardware and software components of the IT asset 106; detecting one or more changes in one or more regulatory standards associated with at least one certification mark to be included in the digitized device regulatory label for the IT asset 106; etc.

Illustrative embodiments provide technical solutions for digital display of regulatory product labels, which may be driven by flashable memory within IT assets that allows for automated content updates required for the regulatory product labels. The technical solutions simplify the problem of having to update or change physical labels on IT assets, which is time consuming for factories. The technical solutions provide various technical improvements, including improvements in regional supply chain management when regulatory information needs to be changed for existing stock. The technical solutions also reduce cost and Bill of Materials (BOM) complexity of physical regulatory labels, and provide faster and more flexible implementation of new regulatory marking requirements to the market. The use of digital displays on IT assets that can simulate or otherwise present the content of regulatory product labels may be accessed, if needed or on demand, by customs officials, installers, etc. Memory modules of IT assets may be provisioned with product regulatory labels for different countries or other geographic regions (e.g., with any needed certification marks specific to different countries or other geographic regions), as well as product regulatory label updates (e.g., including single label updates as used by some storage systems). Updates for the product regulatory labels may be pushed to the IT assets in various ways, including through factory processes, through software bulletins posted on support site, etc.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for managing digitized device regulatory labels for IT assets will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2 . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2 . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for managing digitized device regulatory labels for IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, certification marks, etc. Also, the particular configurations of system and device elements and associated processing operations illustratively shown in the drawings can be varied in other embodiments. Moreover, the various assumptions made above in the course of describing the illustrative embodiments should also be viewed as exemplary rather) than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to identify content to be displayed on at least one version of a digitized device regulatory label for an information technology asset;
to generate said at least one version of the digitized device regulatory label for the information technology asset;
to provision, in a memory of the information technology asset, the generated at least one version of the digitized device regulatory label for the information technology asset; and
to control output of the generated at least one version of the digitized device regulatory label on a display of the information technology asset.

2. The apparatus of claim 1 wherein the at least one processing device comprises a display controller of the information technology asset coupled to the display.

3. The apparatus of claim 2 wherein the display controller comprises one or more interface features for selectively controlling the output of the generated at least one version of the digitized device regulatory label on the display of the information technology asset.

4. The apparatus of claim 3 wherein the generated at least one version of the digitized device regulatory label comprises two or more versions of the digitized device regulatory label, and wherein the one or more interface features enable selection of a given one of the two or more versions of the digitized device regulatory label to output on the display of the information technology asset.

5. The apparatus of claim 1 wherein the display comprises a dedicated display for outputting digitized device regulatory labels.

6. The apparatus of claim 5 wherein the dedicated display comprises an electronic ink display.

7. The apparatus of claim 1 wherein generating the at least one version of the digitized device regulatory label comprises generating a first version of the digitized device regulatory label for a first geographic region and at least a second version of the digitized device regulatory label for a second geographic region, the second geographic region being different than the first geographic region.

8. The apparatus of claim 7 wherein controlling output of the generated at least one version of the digitized device regulatory label on the display of the information technology asset comprises:
determining whether the information technology asset is present in one of the first geographic region and the second geographic region;
responsive to determining that the information technology asset is present in the first geographic region, outputting the first version of the digitized device regulatory label on the display of the information technology asset; and
responsive to determining that the information technology asset is present in the second geographic region, outputting the second version of the digitized device regulatory label on the display of the information technology asset.

9. The apparatus of claim 7 wherein controlling output of the generated at least one version of the digitized device regulatory label on the display of the information technology asset comprises:
determining whether the information technology asset is to be moved to one of the first geographic region and the second geographic region;
responsive to determining that the information technology asset is to be moved to the first geographic region, outputting the first version of the digitized device regulatory label on the display of the information technology asset; and
responsive to determining that the information technology asset is to be moved to the second geographic region, outputting the second version of the digitized device regulatory label on the display of the information technology asset.

10. The apparatus of claim 1 wherein the content of the generated at least one version of the digitized device regulatory label comprises a set of one or more certification marks associated with one or more certification standards.

11. The apparatus of claim 1 wherein identifying the content to be displayed on said at least one version of the digitized device regulatory label, generating said at least one version of the digitized device regulatory label, and provisioning the generated at least one version of the digitized device regulatory label are performed in response to detecting one or more changes in status of the information technology asset.

12. The apparatus of claim 11 wherein at least one of the one or more changes in the status of the information technology asset comprises detecting that the information technology asset has been sold to an end-user in a given geographic region.

13. The apparatus of claim 11 wherein at least one of the one or more changes in the status of the information technology asset comprises detecting one or more changes in at least one of hardware and software components of the information technology asset.

14. The apparatus of claim 11 wherein at least one of the one or more changes in the status of the information technology asset comprises detecting one or more changes in one or more regulatory standards associated with at least one certification mark to be included in the digitized device regulatory label for the information technology asset.

15. A computer program product comprising a non-transitory processor-readable storage medium having stored therein program code of one or more software programs, wherein the program code when executed by at least one processing device causes the at least one processing device:
to identify content to be displayed on at least one version of a digitized device regulatory label for an information technology asset;
to generate said at least one version of the digitized device regulatory label for the information technology asset;
to provision, in a memory of the information technology asset, the generated at least one version of the digitized device regulatory label for the information technology asset; and
to control output of the generated at least one version of the digitized device regulatory label on a display of the information technology asset.

16. The computer program product of claim 15 wherein the content of the generated at least one version of the digitized device regulatory label comprises a set of one or more certification marks associated with one or more certification standards.

17. The computer program product of claim 15 wherein identifying the content to be displayed on said at least one version of the digitized device regulatory label, generating said at least one version of the digitized device regulatory label, and provisioning the generated at least one version of the digitized device regulatory label are performed in response to detecting one or more changes in status of the information technology asset.

18. A method comprising:
identifying content to be displayed on at least one version of a digitized device regulatory label for an information technology asset;
generating said at least one version of the digitized device regulatory label for the information technology asset;
provisioning, in a memory of the information technology asset, the generated at least one version of the digitized device regulatory label for the information technology asset; and
controlling output of the generated at least one version of the digitized device regulatory label on a display of the information technology asset;
wherein the method is performed by at least one processing device comprising a processor coupled to a memory.

19. The method of claim 18 wherein the content of the generated at least one version of the digitized device regulatory label comprises a set of one or more certification marks associated with one or more certification standards.

20. The method of claim 18 wherein identifying the content to be displayed on said at least one version of the digitized device regulatory label, generating said at least one version of the digitized device regulatory label, and provisioning the generated at least one version of the digitized device regulatory label are performed in response to detecting one or more changes in status of the information technology asset.
